(19) United States
(12) Patent Application Publication
(10) Pub. No.: US 2025/0362081 A1
(43) Pub. Date: Nov. 27, 2025

(54) MELTING METHOD USING MULTIPLE IMPACTING FLAMES

(71) Applicant: L'Air Liquide, Societe Anonyme pour l'Etude et l’Exploitation des Procedes Georges Claude, Paris (FR)

(72) Inventors: Chaimae BARIKI, Paris (FR); Remi TSIAVA, Paris (FR)

(21) Appl. No.: 19/213,689

(22) Filed: May 20, 2025

(30) Foreign Application Priority Data
May 23, 2024 (FR) FRFR2405260

(51) Int. Cl. F27B 3/20; C03B 5/235; F27B 3/10; F27B 3/12; F27B 3/28

(52) U.S. Cl. CPC F27B 3/205; C03B 5/2356; F27B 3/10; F27B 3/28; F27B 2003/125

(57) ABSTRACT

The invention relates to a melting method, in which method unmelted charges form a bank 30 resting on one side against the upstream wall 11 of the furnace 10 and having, on the opposite side, a free surface 40; the unmelted charges are heated by means of at least three flames 51, 52, 53 at a regulated power and momentum and are directed towards the free surface 40 so as to define impact zones 41, 42, 43 on this free surface 40 over at least three different distances I1, I2, I3 of one of the side walls 13, 13′ of the furnace 10.

### CROSS-REFERENCE TO RELATED APPLICATIONS

This application claims the benefit of priority under 35 U.S.C. § 119(a) and (b) to French patent application No. FR 2405260, filed May 23, 2024, the entire contents of which are incorporated herein by reference.

### BACKGROUND

The present invention relates to melting methods and furnaces.

### FIELD OF THE INVENTION

In melting methods, a known practice involves introducing the as yet unmelted charge (solid charge), hereafter called “unmelted charges”, into the furnace via chargers.

Pending melting, the unmelted charges form a bank of unmelted charges equal in width to the width of the furnace and of varying height, which can even reach the roof of the furnace.

For example, in the case of some known glass melting furnaces, these unmelted charges float on the bath of already melted raw materials like a carpet and break up into several small islands as they advance through the furnace, before melting completely.

The bank has a free surface that is generally inclined relative to the vertical.

In the case of a combustion melting furnace, at least some of the thermal energy required for progressively melting the solid charge in the bank is provided by one or more burners mounted in the furnace. It is in particular known for the flames to be directed towards the bank of unmelted charges, and in particular towards the inclined free surface of the bank in order to melt the unmelted charges. In this case, the inclined free surface forms a melting front for the unmelted charges in the bank.

In order to ensure high quality for any products manufactured from the molten charge originating from the furnace, the molten charge must be homogeneous and, in particular, without any traces of unmelted charges at the furnace outlet.

To this end, it is essential that the melting front of the bank is located at a certain distance from the furnace outlet.

### RELATED ART

However, in known methods, variations in the position and/or the shape of the melting front can be observed over the width of the furnace, and consequently differences can be observed in the distance between the bank of unmelted charges and the furnace outlet over this width.

The causes of such differences in distances can be incidental, for example, accidental collapse of a section of the free surface of the bank, or structural, for example, due to friction between the bank and the side walls or when introducing the unmelted charges or discharging the molten charge not along the longitudinal axis of the furnace, but through a side wall.

In principle, it is possible to operate the furnace so as to move the free surface of the bank further away from the furnace outlet. However, in this case the productivity of the furnace is reduced.

Furthermore, some charges experience degradation when their temperature exceeds a limit value.

Properly controlling the heating and melting of the solid charge present in the bank is therefore essential.

Heating the inclined free surface of a bank with a single flame or with two flames directed towards the free surface of the bank in order to obtain controlled melting of the melting front is a challenge, particularly when the unmelted charges have low thermal conductivity.

Indeed, the distribution of the thermal energy imparted to the unmelted charges depends on the geometry of the flame and its orientation towards the target surface, with the thermal energy essentially being imparted to the unmelted charges by the flame at the intersection of the flame with the free surface, to the detriment of the other sections of the free surface not impacted by the flame. Furthermore, when the intersection of the flame with the free surface comprises zones closer to and zones further away from the burner generating the flame, this leads to thermal energy distribution in favour of the one or more zones closer to and to the detriment of the one or more zones further away from the burner.

This results in heterogeneous heating and an imbalance in the melting of the bank: the zone receiving the most energy will melt first, leaving a hollow in the bank in its place. The melting of the zones of the bank receiving less energy will be delayed and these zones can, for example, in a continuous furnace, move forward with the molten charge towards the furnace outlet.

Heterogeneous heating thus requires the furnace operator to slow down the charging of raw materials in order to ensure complete melting and, as the case may be, refining of the molten charge in the furnace, which results in a drop in production.

This problem is particularly pronounced in the case of unmelted charges with low heat conductivity. Indeed, in the case of a solid charge with low thermal conductivity, the particles of unmelted charges then transfer little or no heat to each other and the combustion heat received by the free surface of the bank does not reach or only slowly reaches the unmelted charges inside the bank.

### SUMMARY OF THE INVENTION

The aim of the present invention is to at least partly overcome the problem described above.

To this end, the invention proposes a melting method in a furnace. The furnace has a melting zone located between an upstream wall, a downstream wall, opposite the upstream wall, a first side wall, a second side wall, a roof and a bottom.

The two side walls connect the upstream wall and the downstream wall. The distance between the two side walls defines the width I of the furnace. The distance between the upstream wall and the downstream wall defines the length L of the furnace. The distance between the bottom and the roof corresponds to the height of the furnace.

According to the invention, unmelted charges are introduced into the furnace through or on the side of the upstream wall via one or more chargers.

In the present context, “on the side of a wall” is understood to mean: within half the length of the furnace adjacent to said wall, preferably within a third, or even a quarter or a fifth, of the length of the furnace adjacent to said wall.

In the furnace, the unmelted charges form a bank resting on one side against the upstream wall. On the opposite side, the bank has a free surface that is generally inclined relative to the vertical.

The unmelted charges in the bank are heated by means of flames in order to obtain a molten charge, this molten charge is discharged from the furnace through an outlet in or on the side of the downstream wall.

According to the invention, at least three flames are thus directed towards the free surface, with each of these flames defining an impact zone on the free surface of the bank. Said flames are more specifically directed towards the free surface so as to define impact zones on this free surface over at least three different distances from the first side wall.

The distance between an impact zone and another element, such as a wall, within the present context is understood to mean the distance between the centroid or centre of mass of this impact zone and the other element.

Also according to the invention, the thermal energy transferred to the bank by each of these flames in its impact zone is regulated by regulating the power of the flame.

Furthermore, the momentum of each of these flames is regulated so that the flame impacts the free surface in its impact zone without the flame mechanically damaging the structural integrity of the bank in this impact zone.

The method according to the invention has several advantages.

The heating of the unmelted charges in the bank by the flames is distributed over the width of the furnace and therefore over the width of the bank.

The thermal energy transferred to each impact zone is regulated. Thus, it is possible to heat some impact zones more or less than other impact zones and to thus optimise the melting process in each impact zone and therefore also the longitudinal position of this zone of the melting front in the furnace. This type of regulation also avoids overheating the unmelted charges, which is important in the case of unmelted charges that can experience a drop in quality if overheated.

Finally, regulating the momentum of the flames ensures that each flame directed towards the free surface of the bank reaches, i.e., actually impacts, this free surface, but with a momentum that is such that the flame does not mechanically damage the structural integrity of the bank in its impact zone.

Within this context, a distinction is made between, on the one hand, the desired melting of the unmelted charges in the bank and its effect on the shape and the structure of the bank and, on the other hand, the mechanical degradation of the bank, notably by the flames and the combustion gases mechanically picking up any unmelted charges of the bank. Such mechanical degradation can notably result in (i) the presence of unmelted charges in the molten charge discharged from the furnace or in an insufficiently refined molten charge, (ii) in the degradation of the interior of the furnace by the picked up unmelted charges and (iii) in the loss of unmelted charges discharged from the furnace with the combustion fumes.

As indicated above, the flames are directed towards the free surface so as to define at least three impact zones at different distances from the first side wall. Such a configuration therefore clearly differs from a combustion method in which many flames are generated, but in which the flames merge into a single flame downstream of the burner and upstream of the free surface. Indeed, such a merged flame would define a single impact zone on the free surface and not a multitude of impact zones at different distances from the first side wall, as is the case for the multitude of impacting flames according to the present invention.

It should be noted that the present invention does not exclude the presence of heating means in the furnace other than the aforementioned flames directed towards the free surface. Such other heating means can notably include electrical heating elements and/or flames not directed towards the inclined free surface of the bank, for example, above or submerged in the molten charge in a refining zone.

The proposed method with, on the one hand, its regulation of the power of the impacting flames and, on the other hand, its regulation of the momentum of the impacting flames, thus resolves the imbalances in the position of the free surface of the bank observed in known melting methods and consequently increases the production of the furnace, while ensuring homogeneity and the absence of unmelted charges in the molten charge discharged from the furnace. Melting that is better distributed over the inclined free surface corresponding to the melting front of the bank will result in the optimisation of the use of the thermal energy of the flames, which is an energy saving that will be even greater when the method is combined with a system for recovering thermal energy from the fumes discharged from the furnace. The energy that is recovered in this way advantageously can be used to heat one or more combustion reagents (oxidant and/or fuel) by means of a recuperator and/or to preheat at least a fraction of the unmelted charges before they are introduced into the furnace.

As indicated above, according to the method of the invention, the flames are directed towards the free surface so as to define impact zones on the free surface that are located at different distances from the first side wall (and therefore also at different distances from the second side wall, with the impact zone furthest from the first side wall being the impact zone closest to the second side wall).

According to one embodiment, at least four flames are directed towards the free surface so as to define at least four impact zones on the free surface at different distances from the first side wall. Optionally, at least five flames are directed towards the free surface so as to define at least five impact zones on the free surface at different distances from the first side wall.

The selected number of impact zones will depend on the width I of the furnace and on the shape and size, in particular the horizontal dimension, of the impact zones. The use of a small number of impact zones with a large horizontal dimension simplifies the control of the melting method in the sense that the number of flames whose power and momentum have to be regulated is relatively small. The use of a larger number of impact zones allows more localised and therefore more precise regulation of the melting front of the bank, but requires more complex control/regulation.

The distances between the impact zones and the first side wall are preferably distributed over the entire width I of the furnace. The impact zones can be distributed, for example, over the width I of the furnace in a substantially equidistant manner (i.e., with the same difference in the distance between the impact zone and the first side wall for each pair of successive impact zones).

In the case of an odd number of impact zones, one of the impact zones typically will be located in the transverse centre of the furnace (i.e., at a distance from the first (and second) side wall corresponding to half the width I of the furnace), with the other impact zones being located on either side of this central impact zone, typically in equal numbers.

According to a preferred embodiment, the distances between the impact zones and the first side wall are symmetrically distributed over the width I of the furnace relative to half the width I.

Two adjacent impact zones can partially overlap.

According to a preferred embodiment and in order to ensure good distribution of the heating and melting of the impacted free surface, each of the impact zones partially overlaps the nearest impact zone.

The size and shape of an impact zone depend on the geometry of the flame and of the impacted free surface, more specifically on the length of the flame (distance between the root of the flame and its impact zone on the free surface of the bank), on the cross-section of the flame, which is defined by the burner generating the flame, on the opening angle of the impacting flame and on the shape and incline of the impacted free surface.

According to one embodiment, the flames are staggered fuel and/or oxidant injection flames. Staggered combustion is described in the reference books entitled, “Oxygen-Enhanced Combustion”, first edition: ISBN 0-8493-1695-2, page 52, and in, “Oxygen-Enhanced Combustion”, second edition: ISBN 978-1-4398-6228-5, page 458, both edited by Charles E. Baukal Jr. It notably reduces the amount of NOx generated by combustion. Furthermore, suitable positioning of the staggered fuel and/or oxidant injections (such as positioning the staggered injections spaced apart in a horizontal plane of the one or more primary injections) also allows a flame to be obtained with a particular cross-section, such as a cross-section with a horizontal dimension that is greater than its vertical dimension, such as a “flat flame”.

Other means, such as, for example, a burner with a single injection nozzle with a horizontal dimension that is greater than its vertical dimension, also can be implemented in order to achieve such a flame.

As indicated above, the selected number of impact zones will depend, among other things, on the horizontal dimension of the impact zones, which horizontal dimension in turn depends on the width of the cross-section of the flame when it impacts the free surface of the bank. The greater the horizontal dimension of the impact zones, the fewer impact zones are required to cover the free surface of the bank over the entire width I of the furnace.

Thus, according to a useful embodiment, the one or more flames that correspond to an impact zone that is not adjacent to a side wall, or even all the impacting flames, have a cross-section with a horizontal dimension and a vertical dimension, with the horizontal dimension being greater than the vertical dimension, as is notably the case for a flat flame.

This cross-section of the one or more flames notably can be substantially rectangular.

The horizontal dimension of a cross-section or of a zone is understood to mean the dimension along the longest horizontal straight line from one end of said section or said zone to the other. The vertical dimension of a cross-section or zone is understood to mean the dimension along a straight line perpendicular to this horizontal straight line and therefore located in a vertical plane.

In order to better manage the melting method, it also can be worthwhile detecting the position of a section of the free surface of the bank along the length of the furnace, with this section advantageously corresponding to an impact zone, with this position also being referred to as the “state of forward movement”, as it corresponds to a state of forward movement of the unmelted charges towards the furnace outlet for the molten charge. This position can be expressed, for example, as the distance between the upstream wall and the section, with a greater distance between the upstream wall and the section then indicating the considered section is moving closer to the furnace outlet. The position also can be expressed as the distance between the section and the downstream wall, in which case a shorter distance indicates the section and the furnace outlet moving closer together.

According to a preferred embodiment, the position of several sections of the free surface is detected, even of each section of the free surface corresponding to an impact zone.

The position of one or more sections of the free surface of the bank can be detected by means of thermal or optical imaging, or even a combination of the two.

As indicated above, a position of a section too close to the furnace outlet increases the risk of the presence of unmelted charges in the discharged molten charge and/or of incomplete refining of the molten charge upstream of this outlet.

According to an advantageous embodiment, the method involves detecting whether said section reaches a predefined forward movement distance corresponding to the maximum permitted moving closer together of the section and the downstream wall. This predefined forward movement distance corresponds to a forward movement of the considered section towards the downstream wall beyond its desired position. When the section reaches this predefined forward movement distance, the power of the flame corresponding to the impact zone of this section is increased. In this way, it is possible to cause faster melting of the unmelted charges in the vicinity of this section and thus a backward movement of this section from the free surface towards its desired position.

According to another embodiment, which may or may not be combined with the previous embodiment, the method involves detecting whether said section reaches a predefined distance, called “backward movement distance”, corresponding to the maximum permitted moving closer together of the section and the upstream wall. This predefined backward movement distance corresponds to the withdrawal of the section from the free surface relative to its desired position. When the considered section does not reach this predefined backward movement distance, the flame corresponding to the impact zone of this section is reduced. In this way, it is possible to slow down the melting of the unmelted charges in this section and eventually, notably with the introduction of additional unmelted charges into the furnace, to bring this section of the free surface towards its desired position.

As already indicated above, according to the present invention, the momentum of each flame directed towards the free surface is regulated so that the flame impacts the free surface in its impact zone, without the flame mechanically damaging the structural integrity of the bank in the flame impact zone. Consequently, when the position of a section of the free surface of the bank does not correspond or no longer corresponds to its desired position, an adjustment of the corresponding flame momentum also may be necessary in order to ensure that this flame impacts this section of the free surface at its actual position and/or in order to prevent the flame from mechanically damaging the structural integrity of this section of the bank.

When the position of several sections of the inclined free surface of the bank is detected in this way, the predefined forward movement distance and/or the predefined backward movement distance for the various sections can be identical or different depending on the particular features of the furnace, such as, for example, the central or eccentric positioning of the outlet for the molten charge.

The actual position of a section of the inclined free surface of the bank in the furnace can vary, for example, as a function of the production of the furnace (also called the “draw” in the case of a continuous melting furnace), depending on the nature of the unmelted charges introduced into the furnace and/or the molten charge to be obtained. In the case of a discontinuous furnace (often called “batch furnace”), or a semi-continuous furnace (often called “semi-batch furnace”), the position of the sections of the inclined free surface can notably vary during melting, with the melting front thus moving forwards towards the furnace outlet after the introduction of a “batch” of unmelted charges and moving backwards towards the upstream wall as the melting of the unmelted charges progresses. Consequently, in this type of method, the desired position of the sections of the inclined free surface changes over time. According to one embodiment that is suitable for discontinuous or semi-continuous furnaces, it is possible to use a predefined forward distance and/or the predefined backward distance, which also vary over time at the same time as the evolution of its desired position.

In the present context, a semi-continuous melting method or furnace is understood to mean a melting method or furnace in which some of the charge is added or subtracted during the melting cycle.

The impacting flames result from the combustion of a fuel with an oxidant (i.e., a combustion oxidant).

The fuel can be a solid, liquid or gaseous fuel.

Advantageously, the fuel is a gaseous fuel. Such a gaseous fuel can be a carbon-based fuel, a non-carbon-based fuel or a mixture of carbon-based fuel and non-carbon-based fuel. Thus, the fuel particularly can be selected from the following gaseous fuels: natural gas, hydrogen, ammonia, synthesis gas, biogas, any gas containing hydrogen and/or carbon monoxide, and combinations of at least two of these gaseous fuels.

For environmental reasons, non-carbon fuels and renewable fuels with a low carbon footprint.

The oxidant/oxidiser typically has an oxygen content of 16% to 100% by volume. More oxygen rich oxidants/oxidisers, for example, with an oxygen content of at least 90% by volume, are typically more efficient and provide hotter flames, given their low content, or lack, of ballast gas that does not participate in combustion. However, for some applications, an oxidant/oxidiser with a higher ballast content, typically generating more diluted flames, can be preferable.

In order to generate the flames directed towards the free surface of the bank of unmelted charges, the furnace is equipped with at least one burner.

The furnace can be equipped with at least one burner that generates several flames that are directed towards and impact the free surface. The furnace can be equipped with at least one burner that generates a single flame that is directed towards and impacts the free surface. The furnace also can be equipped with a combination of at least one burner that generates several flames that are directed towards and impact the free surface and at least one burner. According to a useful embodiment, the furnace is equipped with a plurality of burners each generating a single flame directed towards the free surface. A burner in the furnace thus can generate a single impacting flame or several impacting flames. The furnace also can be equipped with a combination of burners, including at least one such burner generating a single flame and at least one such burner generating several flames.

In order to implement the method, the melting furnace is generally equipped with:
one or more chargers for introducing the unmelted charges into the furnace;
one or more combustion devices, and notably one or more burners, for generating the flames directed towards the free surface;
a control unit for:
   regulating the power of the flames; and
   regulating the momentum of the flames.

In order to implement particular embodiments of the method according to the invention, the furnace also can be equipped with one or more of the following items of equipment:
a detector for detecting the position of one or more sections of the free surface, preferably of one or more sections of the free surface corresponding to an impact zone defined by a flame impacting the free surface; and
a control unit for comparing the detected position with a predefined forward movement distance and/or for comparing the detected position with a predefined backward movement distance for the section corresponding to an impact zone and for transmitting a control signal to the control unit for regulating the power and the momentum of the flame corresponding to the impact zone of the section based on this comparison.

As mentioned above, the method can be a continuous method, i.e., with a continuous melting furnace, a discontinuous method, therefore, with a discontinuous melting furnace or a semi-continuous method, i.e., with a semi-continuous furnace.

In the case of a discontinuous or semi-continuous method, the melting method can also comprise a step during which the bank is substantially or completely melted and during which there is no free surface on which flames define impact zones. As the case may be, there may not be any combustion in the furnace during this step (particularly when this step is short and/or the heat losses from the furnace are low) or some (generally lower) level of combustion is maintained in order to refine the molten charge or to maintain it at the required temperature above the melting temperature of the charge.

The impacting flames can be directed towards the free surface of the bank from various parts of the furnace. Thus, a flame can be directed towards the free surface through the downstream wall, through a side wall or through the roof of the furnace. A combination of such impacting flames also can be used. For example, the one or more impacting flames corresponding to an impact zone that is not adjacent to one of the side walls can be directed to the free surface through the downstream wall or through the roof, while the impacting flames corresponding to an impact zone adjacent to one of the side walls are directed towards the free surface through this adjacent side wall.

In terms of the flames defining an impact zone adjacent to a side wall, it is worthwhile preventing this flame from being partly directed towards or from impacting this side wall, as such an impact is likely to damage said wall.

To this end, it can be worthwhile using flames with various cross-sections for the impact zones adjacent to one of the side walls and for the one or more impact zones not adjacent to a side wall. For example, according to one embodiment, the one or more impact zones that are not adjacent to a side wall are defined by symmetrical staggered flames with staggered injections of combustion reagent symmetrically positioned relative to the one or more primary injections, whereas the impact zones adjacent to a side wall are defined by asymmetrical staggered flames with one or more staggered injections of combustion reagent positioned only on the side of the one or more primary injections opposite this adjacent side wall.

The method according to the invention is preferably a method for melting glass, a method for melting enamel, a method for melting non-ferrous metal, such as aluminium, lead, copper, etc., and in particular such a method for the second melting of non-ferrous metal, more specifically within the context of recycling one or more non-ferrous metals, for melting hydraulic binder or for vitrifying waste. Consequently, the furnace is preferably a furnace selected from among glass melting furnaces, enamel melting furnaces, non-ferrous metal melting furnaces, hydraulic binder melting furnaces and waste vitrification furnaces.

According to a particularly preferred embodiment of the present invention, any of the embodiments described above can be combined with the method as described in French patent application FR 2405259 filed on 23 May 2024, according to which flames are directed towards the free surface so as to define impact zones on the free surface that are located over at least two different vertical levels. Such a combination not only has the advantage of providing better distribution of the transfer of thermal energy by the flames to the unmelted charges in the bank over the width I of the furnace, resulting from the present invention, but also of providing better distribution of the transfer of thermal energy by the flames to the unmelted charges in the bank over the height h of the bank and therefore even more effective control of the melting of the unmelted charges in the vicinity of the melting front of the bank.

### BRIEF DESCRIPTION OF THE FIGURES

FIG. 1 is a schematic representation, as a cross-section of an embodiment of a furnace.

FIG. 2 is a schematic representation, as a top view of an embodiment of furnace.

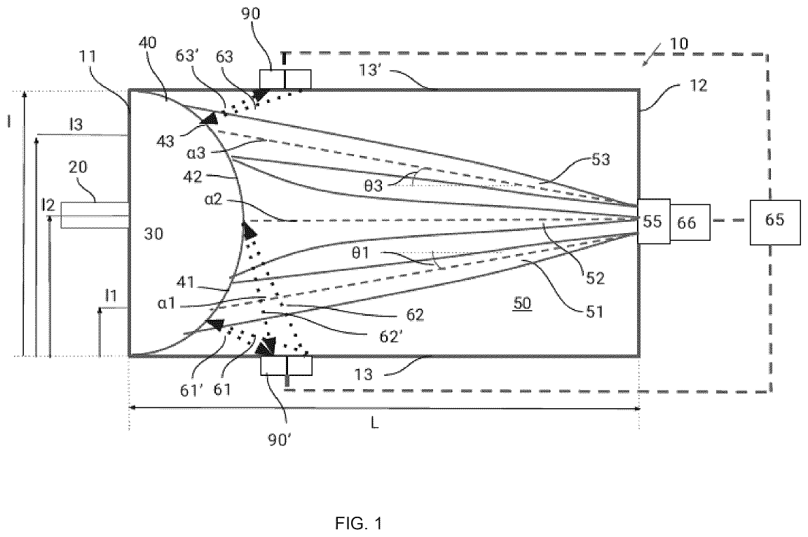

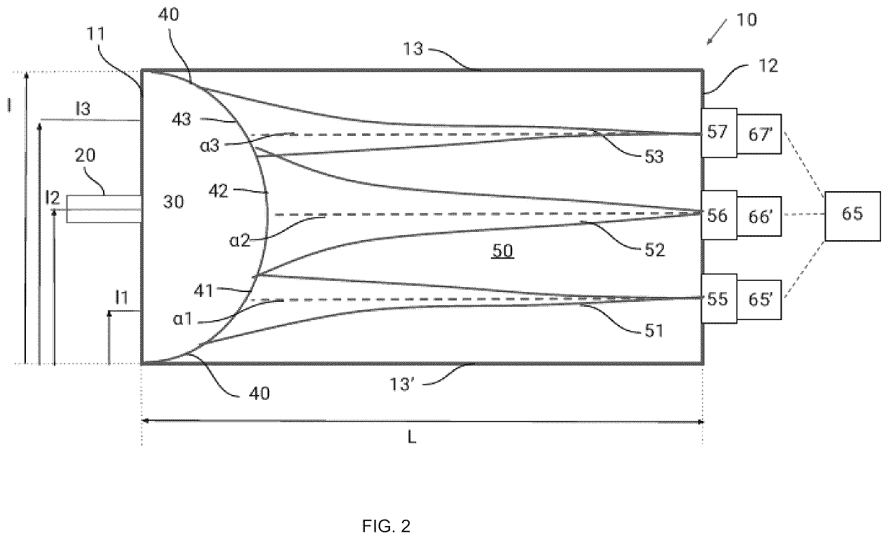

The present invention and its advantages will be better understood in the light of the following non-limiting example, with reference to FIGS. 1 and 2, which are schematic representations, as a cross-section and top view, of two embodiments of a furnace in which the method according to the invention is implemented.

### DETAILED DESCRIPTION OF THE INVENTION

FIG. 1 more specifically shows a continuous furnace 10 for melting glass.

The furnace 10 has an upstream wall 11, through which the unmelted charges (i.e., the solid vitrifiable composition) is introduced into the furnace 10, and a downstream wall 12, opposite the upstream wall 11, and through which the molten glass 50 is discharged from the furnace 10.

Two side walls 13, 13′ connect the upstream wall 11 and the downstream wall 12.

The furnace 10 also has a roof and a bottom (not illustrated in the figures), with the melting zone being located between the upstream wall 11, the downstream wall 12, the side walls 13 and 13′, the roof and the bottom.

The solid vitrifiable composition is made up of or comprises small particles with low thermal conductivity compared with the thermal conductivity of metals. These particles therefore transmit little or no thermal energy between them.

The unmelted charges are introduced into the furnace 10 through the upstream wall 11, for example, by means of an endless screw 20. In the illustrated embodiment, this charger 20 is located in the centre of the upstream wall 11. Inside the furnace 10, the unmelted charges form a pile in the form of a bank 30 that extends above the molten glass 50. On the upstream side of the furnace 10, the bank 30 of unmelted charges rests against the upstream wall 11. Towards the downstream side, the bank 30 ends at a free surface 40 that is inclined relative to the vertical and is curved towards the downstream wall 12.

To heat and melt the unmelted charges, the free surface 40 is attacked by the fan-shaped flames 51, 52, 53 generated by the burner 55 mounted in the downstream wall 12. The free surface 40 consequently forms a melting front for the unmelted charges in the furnace 10.

The furnace 10 illustrated in FIG. 1 is a small furnace.

Furnaces of the illustrated type assume a parallelepiped shape and generally have a length L (between the upstream wall 11 and the downstream wall 12) of less than 10 metres, a width I (between the side wall 13 and the side wall 13′) of less than 5 metres and a height of less than 3 metres.

The bank 30 to be melted is located on the side of the upstream wall 11 and the burner 55 is located on the opposite downstream wall 12. The burner 55 is selected so as to emit a flame length that matches the length of the furnace 10. The molten material 50 moves over the bottom of the furnace 10 towards the burner 55, below which an outlet hole (not illustrated) is located for the molten material 50. The molten material 50 thus moves under the flames 51, 52, 53, which keep it molten until it leaves the furnace 10.

For larger furnaces, the bank 30 to be melted remains on the side of the upstream wall 11, but additional burners are added. These additional burners can be installed, for example, on the side walls 13, 13′ connecting the upstream wall 11 and the downstream wall 12, in the roof or in the bottom, for “submerged burners”.

Each flame 51, 52, 53 defines an impact zone 41, 42, 43 on the free surface 40, where it causes the unmelted charges to melt.

The flames 51, 52, 53 are directed towards the free surface 40 in different directions α1, α2, α3 (depicted by the axes of the flames 51, 52, 53) forming various acute angles (≥0°) θ1, θ2, θ3 with the vertical plane through the longitudinal axis of the furnace. In this way, the respective impact zones 41, 42, 43 of the flames 51, 52, 53 are each located at a different distance I1, I2, I3 from the first side wall 13 (and consequently also at a different distance from the second side wall 13′). In the illustrated case, the direction α2 of the flame 52 lies in the vertical plane including the longitudinal axis of the furnace 10 and the directions α1 and α3 of the flames 51, respectively 53, lie on either side of this vertical plane and form acute angles with this vertical plane. In the embodiment illustrated in FIG. 1, the angle θ2 is therefore 0° and consequently is not visible in the figure.

Depending on the width I of the furnace 10 and the horizontal dimension of the flames 51, 52, 53, a greater number of impacting flames may be necessary in order for the impact zones 41, 42, 43 to cover the free surface 40 of the bank 30 well enough over the entire width I of the furnace. If necessary, additional burners can be installed in the furnace 10 in order to generate these additional flames.

As illustrated in FIG. 2, it is also possible to use one burner 55, 56, 57 per impacting flame 51, 52, 53. According to FIG. 2, each impacting flame 51, 52, 53 has a direction α1, α2, α3 parallel to the side walls 13, 13′ and therefore also parallel to the aforementioned vertical plane.

However, other configurations can be contemplated. For example, according to a non-illustrated embodiment, the flame 52 is generated by a burner 56 located in the downstream wall 12 and has a direction α2 as shown in FIG. 2. By contrast, the flame 53 is generated by a burner 57 mounted in the side wall 13, but the direction α3 of the flame 53 is selected such that this flame 53 defines the same impact zone 43 as in FIG. 2, with the flame 51 being generated by a burner 55 mounted in the other side wall 13′, with the direction α1 of the flame 51 being selected such that this flame 51 defines the same impact zone 41 as in FIG. 2.

The thermal energy transferred to the unmelted charges in the bank 30 by each flame 51, 52, 53 via its respective impact zone 41, 42, 43 is regulated by regulating the power of the corresponding flame 51, 52, 53. By regulating the power of the flames 51, 52, 53, the melting rate of the unmelted charges in the vicinity of the corresponding impact zone 41, 42, 43 is also regulated. This notably prevents the free surface 40 from advancing too far towards the downstream wall 12 in the vicinity of this impact zone 41, 42, 43, or even the surface 40 from moving too far back towards the upstream wall 11 in the vicinity of this impact zone 41, 42, 43.

The momentum of each flame 51, 52, 53 is also regulated. This momentum is more specifically regulated so that the flames 51, 52, 53, on the one hand, impact the free surface 40 of the bank 30, which allows more effective heating of the unmelted charges, and, on the other hand, do not mechanically damage the structural integrity of the bank 30.

Since the momentum of the flames 51, 52, 53 is regulated so that said flames 51, 52, 53 impact the free surface 40, the flames that correspond to impact zones furthest from the root of the flame/burner 55, 56, 57 typically have stronger momentums than the flames that correspond to impact zones closer to the root of the flame/burner 55, 56, 57.

As indicated above, in the present context, a distinction is made between, on the one hand, changing the bank by melting the unmelted charges and, on the other hand, the mechanical degradation of the structural integrity of the bank by high momentum flames, notably by the unmelted charges of the bank being uncontrollably mechanically picked up by such flames and/or by the combustion fumes/gas generated by such flames.

For regulating the momentum of the flames 51, 52, 53, the distance between the free surface 40 and the root of the flames 51, 52, 53/the outlet of the one or more burners 55, 56, 57 generating the flames 51, 52, 53 and the nature of the unmelted charges is therefore taken into account.

Thus, when the bank is made up of large and heavy pieces of non-ferrous metal that are difficult to pick up, the momentum of the flames can be relatively high.

By contrast, when the bank is made up of or comprises unmelted charges in the form of light particles/fine particles/powders, as in the illustrated embodiment, and in particular such fine particles/powders that do not stick together when they enter the furnace, the momentum of the impacting flames must remain fairly low in order to avoid such picking up or in order to avoid significant picking up of said particles.

It should be noted that such picking up can result in:
(i) the presence of unmelted charges in the molten charge discharged from the furnace or an insufficiently refined molten charge, which can cause problems in the methods downstream of the melting step, such as the shaping of solid products from the molten charge, and a reduction in the quality of the manufactured solid products;
(ii) degradation of the interior of the furnace, for example: erosion of the walls by picked up unmelted charges and the formation of deposits on burners or other equipment in contact with the interior of the furnace; and/or
(iii) the loss of unmelted charges discharged from the furnace with the combustion fumes. Such a loss of raw materials is obviously costly. It can also cause blockages in the flue gas evacuation ducts and accelerated saturation of the filters used for flue gas treatment upstream of the chimney. When the furnace comprises a system for recovering thermal energy from the exhaust fumes, the presence of unmelted charges in the fumes also poses problems for heat recovery in the recuperators or regenerators that are used. Furthermore, when the charge is a mixture of various ingredients, as is notably the case for glass melting methods, the discharge of unmelted charges with the combustion fumes can be selective, with various discharge levels for various ingredients. In this case, the composition of the molten charge that is obtained does not correspond to that resulting from the composition of the unmelted charges introduced into the furnace, with obvious consequences for the methods for treating the molten charge downstream of the furnace and for the properties of the final product that is obtained.

Burners allowing such dual regulation, on the one hand, of the power of the one or more generated flames and, on the other hand, of the momentum of the one or more generated flames are known. Such burners are described, for example, in WO-A-2010/003866. Such a burner allows, for example, modification of the power of the constant-momentum flame or modification of the momentum of the constant-power flame.

It is generally desirable for one or more features of the melting method to be detected that allow the melting method to be optimised.

According to one advantageous embodiment, electromagnetic beams, and notably laser beams, are used to detect the position of the free surface 40 in the furnace 10, preferably in a section corresponding to one or more impact zones 41, 42, 43 during the melting method.

According to the embodiment illustrated in FIG. 1, an electromagnetic beam 61, 62, 63, more specifically a laser beam, is emitted by an emission/detection unit 90, 90′ mounted in the side walls 13, 13′ and directed towards a section of the free surface 40 of the bank 30. The beam is reflected by this section of the free surface 40 and the reflected beam 61′, 62′, 63′ is detected by the emission/detection unit 90, 90′. The position of the section of the free surface 40 that reflects the laser beam 61, 62, 63 is determined by the emission/detection unit 90, 90′ based on the time difference between the emission of the laser beam 61, 62, 63 and the detection of its reflection 61′, 62′, 63′, with this time difference being a measure of the distance travelled by the beam between its emission and its detection. A signal corresponding to the position of the relevant section of the free surface 40 is transmitted by the emission/detection unit 90, 90′ to the control unit 65.

The control unit 65 compares the position detected by the transmission/detection unit 90, 90′ with a predefined forward movement distance and/or a predefined backward movement distance for this section, preferably with a predefined forward movement distance and a predefined backward movement distance.

If it follows from this comparison that the section of the free surface 40 has reached the predefined forward movement distance, which corresponds to this section of the free surface 40 moving closer to the outlet of the furnace 10, the control unit 65 transmits a control signal to the control unit 66, 65′, 66′, 67′ of the burner 55, 56, 57 so that the power of the flame 51, 52, 53 that corresponds to an impact zone 41, 42, 43 in this section is increased, which allows the melting of the unmelted charges in the vicinity of this section of the free surface 40 to be accelerated, thus causing this section to move back towards the upstream surface 11 of the furnace 10.

If, by contrast, it follows from this comparison that the section of the free surface 40 does not reach the predefined backward movement distance, which corresponds to a backward movement of the section of the free surface 40 towards the upstream wall 11 of the furnace, the control unit 65 transmits a control signal to the control unit 66, 65′, 66′, 67′ of the burner 55, 56, 57 so that the power of the flame 51, 52, 53 that corresponds to an impact zone 41, 42, 43 in this section is reduced, which allows the melting of the unmelted charges in this section to be slowed down and eventually, notably with the introduction of additional unmelted charges into the furnace 10, allows this section of the free surface 40 to be brought towards its desired position.

If necessary, the control unit 66, 65′, 66′, 67′ at the same time will adjust the momentum of the one or more relevant flames so that these flames actually impact the free surface 40 of the bank 30 in the section at its actual position, without the flame 51, 52, 53 mechanically damaging the structural integrity of the bank 30.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1. A method for melting in a furnace having a melting zone located between an upstream wall, a downstream wall, opposite the upstream wall, a first side wall and a second side wall, with the two side walls connecting the upstream wall and the downstream wall, a roof and a bottom, with the distance between the upstream wall and the downstream wall defining the length L of the furnace and the distance between the two side walls defining the width I of the furnace;
the method comprising:
introducing unmelted charges into the furnace through or on the side of the upstream wall via one or more chargers;
forming in the furnace, a bank with the unmelted charges resting on one side against the upstream wall and having, on the opposite side, a free surface that is inclined relative to the vertical;
heating the unmelted charges in the bank by means of flames in order to obtain a molten charge; and
discharging the molten charge is discharged from the furnace through an outlet in or on the side of the downstream wall;
wherein,
at least three flames are directed towards the free surface so as to define impact zones on this free surface over at least three different distances from the first side wall;
the thermal energy transferred to the bank by each flame in the respective impact zone is regulated by regulating the power of the flame; and
the momentum of each flame is regulated so that the flame impacts the free surface in the impact zone without the flame mechanically damaging the structural integrity of the bank in this impact zone.

2. The method according to claim 1, wherein at least four flames are directed towards the free surface so as to define impact zones on this free surface over at least four different distances from the first side wall.

3. The method according to claim 1, wherein the distances are distributed over the entire width I of the furnace.

4. The method according to claim 1, wherein the distances are symmetrically distributed over the width I of the furnace relative to the centre of this width I.

5. The method according to claim 1, wherein each impact zone partially overlaps the nearest impact zone.

6. The method according to claim 1, wherein the one or more flames corresponding to an impact zone that is not adjacent to a side wall have a cross-section with a horizontal dimension and a vertical dimension, with the horizontal dimension being greater than the vertical dimension.

7. The method according claim 5, wherein said cross-section is rectangular.

8. The method according to claim 1, wherein the flames are staggered fuel and/or oxidant injection flames.

9. The method according to claim 1, wherein a position of a section of the free surface is detected.

10. The method according to claim 9, wherein the position of several sections of the free surface is detected.

11. The method according to claim 1, involving detecting whether a section of the free surface corresponding to an impact zone reaches a predefined forward movement distance and involving increasing the power of the flame corresponding to this impact zone when the section reaches this predefined forward movement distance.

12. The method according to claim 1, involving detecting whether a section of the free surface corresponding to an impact zone reaches a predefined backward movement distance and involving reducing the power of the flame corresponding to this impact zone when the section does not reach this predefined backward movement distance.

13. The method according to claim 1, wherein the method is a continuous, discontinuous or semi-continuous method.

14. The method according to claim 1 for melting glass, enamel, non-ferrous metal, hydraulic binder or for vitrifying waste.
